(19) United States
(12) Patent Application Publication
(10) Pub. No.: US 2004/0187437 A1
(43) Pub. Date: Sep. 30, 2004

(54) Laminated strength-reinforced window assemblies

(76) Inventor: David H. Stark, Evergreen, CO (US)

Correspondence Address: HOWISON & ARNOTT, L.L.P, P.O. BOX 741715, DALLAS, TX, 75374-1715, US

(21) Appl. No.: 10/811,408

(22) Filed: Mar. 26, 2004

Related U.S. Application Data
(60) Provisional application No. 60/458,157, filed on Mar. 27, 2003.

(51) Int. Cl. B32B 5/12; E04C 2/54

(52) U.S. Cl. 52/786.12

(57) ABSTRACT

A laminated strength-reinforced window assembly comprises a sheet of strength-reinforced transparent material, first and second transparent windowpane sheets. The strength-reinforced sheet has a tensile strength value, an impact resistance value, an environmental resistance value, an upper sealing surface and a lower sealing surface. Each windowpane sheet has a respective tensile strength value, impact resistance value and environmental resistance value. The first sheet is disposed over at least a part of the upper sealing surface and the second sheet is disposed under at least a part of the lower sealing surface. At least one of the tensile strength value, the impact resistance value and the environmental resistance value of the strength-reinforced material is significantly greater than the corresponding value of one of the first and second windowpanes. The windowpane sheets are hermetically bonded to the sheet of strength-reinforced material without non-hermetic adhesives to form a continuous hermetic joint therebetween.

### CROSS-REFERENCE TO RELATED APPLICATIONS

This application claims the benefit of priority from U.S. Provisional Application 60/458,157 (Dkt. No. STRK-26,583) filed Mar. 27, 2003.

### TECHNICAL FIELD OF THE INVENTION

The current invention relates to laminated transparent materials, and more particularly, to laminated strength-reinforced window assemblies and methods for fabricating such assemblies.

### BACKGROUND OF THE INVENTION

It is known to make laminated glass window assemblies by bonding a plurality of sheets or layers of glass together using glue, resin or other chemical adhesives. It is further known to make strength-reinforced “safety glass” window assemblies by bonding a sheet or layer of transparent non-glass material such as plastic between two sheets or layers of glass using glue, resin or other chemical adhesives.

A problem with such prior art laminated window assemblies is the tendency for the layers to delaminate, or separate from one another. This delamination may be the result of a failure of the adhesive's bond to the glass and/or non-glass sheets (e.g., due to imperfect compatibility or surface contaminants), a chemical breakdown of the adhesive (e.g., due to exposure to light or heat), or a structural failure of the adhesive caused by excessive tensile and/or shear stress withing the adhesive layer. Delaminations are typically undesirable because they can affect the optical qualities, strength and/or perceived quality of the window assembly. A need therefore exists, for laminated window assemblies having increased resistance to delamination.

### SUMMARY OF THE INVENTION

The present invention disclosed and claimed herein comprises, in one aspect thereof, a laminated strength-reinforced window assembly comprising a sheet of strength-reinforced transparent material, first and second transparent windowpane sheets. The strength-reinforced sheet has a tensile strength value, an impact resistance value, an environmental resistance value, an upper sealing surface and a lower sealing surface. Each windowpane sheet has a respective tensile strength value, impact resistance value and environmental resistance value. The first sheet is disposed over at least a part of the upper sealing surface and the second sheet is disposed under at least a part of the lower sealing surface. At least one of the tensile strength value, the impact resistance value and the environmental resistance value of the strength-reinforced material is significantly greater than the corresponding value of one of the first and second windowpanes. The windowpane sheets are hermetically bonded to the sheet of strength-reinforced material without non-hermetic adhesives to form a continuous hermetic joint therebetween.

The present invention disclosed and claimed herein comprises, in another aspect thereof, a laminated strength-reinforced window assembly comprising n sheet(s) of strength-reinforcing material, where n>=1, and (n+1) transparent windowpane sheets. Each sheet of strength-reinforcing material has a tensile strength value, an impact resistance value, an upper sealing surface and a lower sealing surface. Each windowpane sheet has a respective tensile strength value, a respective impact resistance value and a respective environmental resistance value. The windowpane sheets are interleaved with the sheet(s) of strength-reinforcing material such that one sheet of strength-reinforcing material lies against each consecutive windowpane sheet. The sheet of strength-reinforcing material is disposed to have at least a part of the upper sealing surface overlapping one of the adjacent windowpane sheets, and at least a part of the lower sealing surface overlapping the other adjacent windowpane sheet. At least one of the tensile strength value, the impact resistance value and the environmental resistance value of each sheet of strength-reinforced material is significantly greater than the corresponding value of one of the directly adjacent windowpane sheets. All of the windowpane sheets are hermetically bonded to the adjacent sheet(s) of strength-reinforcing material without non-hermetic adhesives.

The present invention disclosed and claimed herein comprises, in yet another aspect thereof, a method for producing laminated strength-reinforced window assemblies, including the following steps: Providing a sheet of strength-reinforced transparent material having an upper sealing surface and a lower sealing surface, the upper sealing surface being disposed on the upper side of the strength-reinforced sheet, and the lower sealing surface being disposed on the lower side of the strength-reinforced sheet. Providing a first and a second transparent windowpane sheets. Positioning the first windowpane sheet against at least a part of the upper sealing surface, the overlap between them defining an upper junction, and positioning the second windowpane sheet against at least a part of the lower sealing surface, the overlap between them defining a lower junction. Pressing the windowpane sheets against the sheet of strength-reinforced material with sufficient force to produce a predetermined contact pressure throughout the upper and lower junctions. Heating the junctions to produce a predetermined temperature throughout the junctions. Maintaining the predetermined contact pressure and the predetermined temperature until a diffusion bond is formed between the windowpane sheets and the sheet of strength-reinforced material throughout the junction.

The present invention disclosed and claimed herein comprises, in still another aspect thereof, a laminated strength-reinforced window assembly comprising a first and a second sheet of transparent materials. Each sheet has a tensile strength value, an impact resistance value, an environmental resistance value and a sealing surface. At least one of the tensile strength value, the impact resistance value and the environmental resistance value of the material of the first sheet is significantly greater than the corresponding value of the material of the second sheet. The sealing surface of the first sheet is disposed against the sealing surface of the second sheet. The first and second sheets are hermetically bonded to one another along the sealing surfaces without non-hermetic adhesives to form a continuous hermetic joint therebetween.

### BRIEF DESCRIPTION OF THE DRAWINGS

FIG. 1a is an exploded view of the components of a laminated strength-reinforced window assembly in accordance with one embodiment of the current invention prior to joining;

FIG. 1b shows the completed window assembly of FIG. 1a after joining;

FIG. 2a is an exploded view of the components of a laminated strength-reinforced window assembly in accordance with another embodiment prior to joining;

FIG. 2b shows the completed window assembly of FIG. 2a after joining;

FIG. 3 is an exploded view of the components of a laminated strength-reinforced window assembly including interlayers in accordance with yet another embodiment of the current invention prior to joining;

FIG. 4 illustrates one apparatus for fixturing multiple sets of laminated strength-reinforced window assemblies for simultaneous bonding;

FIGS. 5a, 5b and 5c, illustrate fixtures for aligning and compressing the window assemblies during diffusion bonding; specifically:

FIG. 5a illustrates an empty fixture and clamps;

FIG. 5b illustrates the fixture of FIG. 5a with a window assembly positioned therein for bonding; and

FIG. 5c illustrates an alternative fixture designed to produce more axial pressure on the window assembly.

### DETAILED DESCRIPTION OF THE INVENTION

Attachment of pairs of glass windowpanes or other transparent materials to a strength-reinforcing material is performed to create laminated, strength-reinforced window assemblies. These assemblies may also be termed strength-enhanced window assemblies. It will be appreciated that, for purposes of this application, the terms “strength-reinforced material” and “strength-reinforcing material” refer to materials having a significantly greater tensile strength and/or significantly greater impact resistance and/or significantly greater environmental resistance. (e.g., abrasion resistance, solvent resistance, resistance to high or low pH, etc.) than the adjacent windowpane material. Through the use of selected combinations of transparent or opaque windowpane materials bonded to opposite sides of a strength-reinforcing material, laminated window assemblies are provided that are resistant to severe impacts such as bullet strikes. Further, these window assemblies can be made bulletproof as well as impervious to more severe weapons systems while weighing less than the types of bulletproof windows now available.

Preferably, the joint between the sheets forming the laminated strength-reinforced window assemblies will be hermetic, i.e., maintaining its gas-tight integrity indefinitely. Such joints better resist delamination and are generally stronger than non-hermetic joints. However, conventional adhesives, such as rubber, glues, epoxies and resins, are non-hermetic. To obtain a true hermetic joint/bond between the layers of the laminated strength-reinforced window assemblies, such non-hermetic adhesives cannot be used. Instead, processes such as diffusion bonding, as further explained herein, must be used.

As will be further described herein, the strength-reinforcing material is sandwiched between the two outer transparent materials. This inner-layer strength-reinforcing material is semi-transparent or totally transparent when used in the production of semi-transparent or transparent windows. Examples of semi-transparent reinforcement materials include, but are not limited to transparent or semi-transparent woven or mesh materials; thin, solid sheets of transparent or semi-transparent polycarbonate or other composite materials; thin or thick-film metals, ceramics, and glasses. The final assembly may have two, three or more windowpanes (or other transparent materials), with each pair of windowpanes separated by, and joined to an intervening layer of strength-reinforcing material. The two, three or more windowpanes need not all be formed of the same material composition. Similarly, the one, two or more strength-reinforcing sheets/layers need not all be formed of the same composition.

It will be appreciated that neither the components of the strength-reinforced laminated window assemblies, nor the complete assemblies themselves, need to be flat. They may be concave, convex or complex in shape, as long as each windowpane mates intimately with the adjacent strength-reinforcement layer, e.g., during the bonding process, the surface of glass (or other windowpane material) is in intimate contact with the surface of the strength-reinforcement layer to which it is bonded.

It will be further appreciated that the windowpane material need not be glass. It could be a different transparent or non-transparent material, including, but not limited to quartz, sapphire, silicon and even metals, metal alloys, and ceramics. It could be a non-hermetic material, but the resulting assembly would then be non-hermetic.

Referring now to FIGS. 1a and 1b, there is illustrated a laminated strength-reinforced window assembly in accordance with one embodiment. FIG. 1a is an exploded view of the components prior to fixturing, while FIG. 1b shows the completed assembly. Window assembly 100 includes a sheet of strength-reinforced transparent material 102, a first transparent windowpane sheet 104 and a second transparent windowpane sheet 106. The windowpane sheets 104 and 106 may be formed of the same material or different materials. Each of the sheets 102, 104 and 106 has a tensile strength value, an impact resistance value and an environmental resistance value. At least one of the tensile strength, the impact resistance and/or the environmental resistance of the material of strength-reinforced sheet 102 is significantly greater than the corresponding value of the material of at least one of the windowpane sheets 104 and 106. It will be appreciated that only one of these values must be greater in the strength-reinforced sheet 102 than in the windowpanes 104 and 106, and the other two values may be less, although in some cases, two or all three values may be greater.

The first windowpane sheet 104 is disposed over at least a part of the upper sealing surface 108 of the strength-reinforced sheet 102, the overlap between them (i.e., viewed from above) defining an upper junction area. The second windowpane sheet 106 is disposed under at least a part of the lower sealing surface 110 of the strength-reinforced sheet 102, the overlap between them defining a lower junction area. The first and second transparent windowpane sheets 104 and 106 are each hermetically bonded to the sheet of strength-reinforced material 102 throughout the overlapping junction to form a continuous hermetic joint therebetween. Obviously, this hermetic joint is formed without the use of non-hermetic adhesives such as rubber, glues, epoxies and resins.

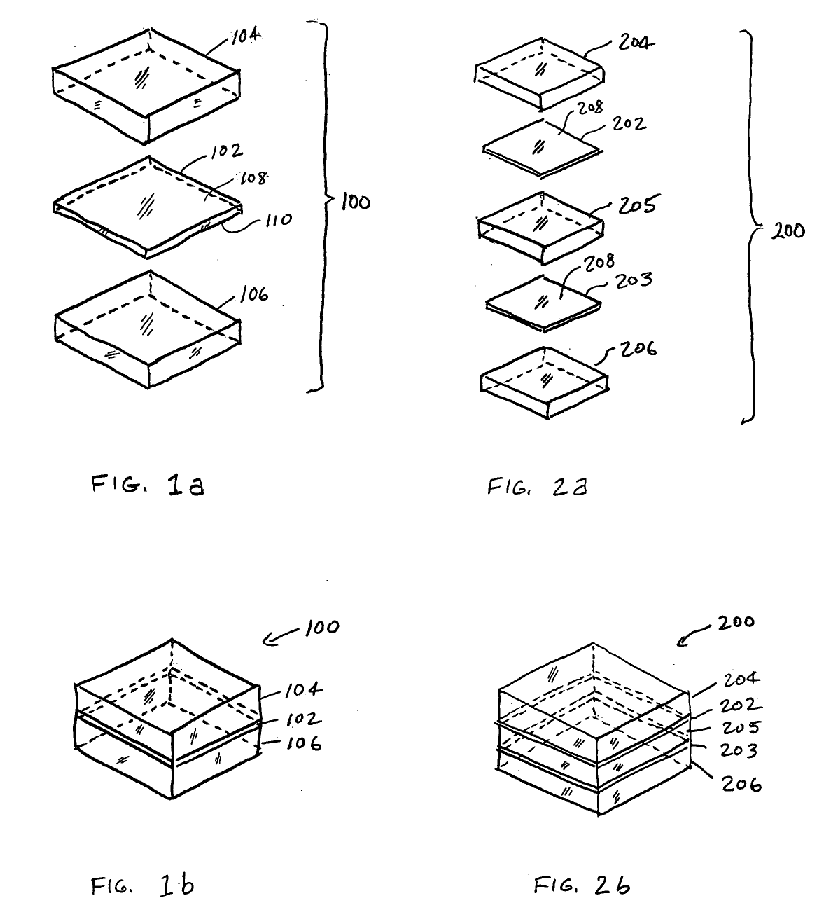

Referring now to FIGS. 2a and 2b, there is illustrated a laminated strength-reinforced window assembly in accordance with another embodiment in which two strength-reinforcing layers are sandwiched between three windowpanes. FIG. 2a is an exploded view of the components prior to fixturing, while FIG. 2b shows the completed assembly. Window assembly 200 includes two sheets of strength-reinforced transparent material 202 and 203, which may be formed of the same material or different materials. It further includes first, second and third transparent windowpane sheets 204, 205 and 206, which may also be formed of the same material or different materials. As in the previous embodiment, each of the sheets 202, 203, 204, 205 and 206 has a tensile strength value, an impact resistance value and an environmental resistance value. At least one of the tensile strength, the impact resistance and/or the environmental resistance of the materials of strength-reinforced sheets 202 and 203 is significantly greater than the corresponding value of the material of one of the adjacent windowpane sheets 204, 205 and 206. Again, only one of these values must be greater in the strength-reinforced sheet 202 and 203 than in the adjacent windowpanes 204, 205 and 206.

The strength-reinforced sheets 202 and 203 are interleaved with the windowpane sheets 204, 205 and 206 such that one sheet of strength-reinforced material lies against each consecutive windowpane sheet with the upper sealing surface 208 of each sheet 202 and 203 overlapping one of the adjacent windowpane sheets. The first, second and third transparent windowpane sheets 204, 205 and 206 are each hermetically bonded to the intervening sheets of strength-reinforced material 202 and 203 to form a continuous hermetic joint throughout the overlapping area. This hermetic joint is formed without the use of non-hermetic adhesives such as rubber, glues, epoxies and resins.

Although FIGS. 2a and 2b show the assembly of a triple-pane window assembly, there is no limit to the number of window pieces (windowpanes), with intermediate strength-reinforcing layers between pairs of window pieces, that may be used to form a window assembly. For example, an assembly could be constructed with four windowpanes and three strength-reinforcing layers, five windowpanes and four strength-reinforcing layers, etc. Further, the assembly can be constructed of two layers only, e.g., a first windowpane bonded directly to a second windowpane, or alternatively, to a single strength-reinforcing layer.

It is currently believed that the preferred process for hermetically joining the transparent windowpanes to the strength-reinforcing layer is diffusion bonding. Diffusion bonding is a process by which a joint can be made between similar and dissimilar metals, alloys, and nonmetals, through the action of diffusion of atoms across the interface, brought about by the bonding pressure (load) and heat applied for a specified length of time. The bonding variables (temperature, load and time) vary according to the kind of materials to be joined, surface finish, and the expected service conditions.

It will be appreciated that the terms “diffusion bonding” and “thermal compression bonding” (and its abbreviation “TC bonding”) are often used interchangeably throughout this application and in the art. The term “diffusion bonding” is preferred by metallurgists while the term “thermal compression bonding” is preferred in many industries (e.g., semiconductor manufacturing) to avoid possible confusion with other types of “diffusion” processes used for creating semiconductor devices. Regardless of which term is used, as previously discussed, diffusion bonding refers to the family of bonding methods using heat, pressure, specific positive, ambient or negative pressure atmospheres and time alone to create a bond between mating surfaces at a temperature below the normal fusing temperature of either mating surface. In other words, neither mating surface is intentionally melted, and no melted filler material is added, nor any chemical adhesives used.

A very important distinction of diffusion bonding (as compared to other bonding processes) is the high quality of the resulting joints. It is the only process known to preserve the properties inherent in monolithic materials, in both metal-to-metal and nonmetal joints. With properly selected process variables (temperature, pressing load and time), the material at and adjacent to the joint will have the same strength and plasticity as the bulk of the parent material(s). When the process is conducted in vacuum, the mating surfaces are not only protected against further contamination, such as oxidation, but are cleaned, because the oxides present dissociate, sublime, or dissolve and diffuse into the bulk of the material. A diffusion weld is free from incomplete bonding, oxide inclusions, cold and hot cracks, voids, warpage, loss of alloying elements, etc. Since the edges are brought in intimate contact, there is no need for fluxes, electrodes, solders, filler materials, etc. Diffusion-bonded parts usually retain the original values of ultimate tensile strength, angle of bend, impact toughness, vacuum tightness, etc.

In some cases, the bonding process for joining pairs of glass windowpanes (or other window materials) to an intervening layer of strength-reinforcing material may be done in vacuum or partial vacuum (an evacuated chamber), vacuum with the addition of one or more gases to increase or accelerate reduction of oxides (such as, but not limited to hydrogen), and vacuum with the addition of one or more inert gases such as argon. In other cases, the bonding maybe done in a special atmosphere to increase oxidation of the strength-reinforcing material and/or the window material. This special atmosphere could be a negative pressure, ambient pressure or positive pressure, with one or more gasses added to promote (instead of reduce) the oxidation of the reinforcement material and/or the window material. The added gasses for promoting oxidation include, but are not limited to oxygen.

In some instances, the bond (joint) resulting from the bonding process will exhibit a chemical bond between the inner-layer strength-reinforcing material and the glass (or other window material). This chemical bond may be in addition to evidence of a diffusion bond (atomic diffusion). In other instances, the bond (joint) will exhibit little or no evidence of atomic diffusion.

The strength-reinforcing layers of the laminated window assemblies of the current invention may comprise one or more materials. These materials include, but are not limited to: a glass material; a metal material; a metal alloy material; a ceramic material; composite materials; woven or mesh materials, comprising one or more of the previously listed materials; woven or mesh materials, comprising one or more of the previously listed materials, encapsulated in a composite material; and a material comprising a combination of two or more of the previously listed materials. Additionally, the inner-layer strength-reinforcing material may be coated or plated to promote bonding to the window material. Coatings could include, but are not limited to: a glass material; a metal material; a metal alloy material; ceramics; glass or glasses; composite materials; and woven or mesh materials encapsulated in a composite material.

As previously described, diffusion bonding utilizes a combination of elevated heat and pressure to hermetically bond two surfaces together without first causing one or both of the adjoining surfaces to melt (as is the case with conventional soldering, brazing and welding processes). When making laminated strength-reinforced window assemblies, it is almost always required that the bonding temperatures remain below some upper limit. For example, in laminated window assemblies, the bonding temperature should be below the glass transition temperature, T_{G}, and the softening temperature, T_{S}, of both the windowpane and strength-reinforcing materials so as not to affect the pre-existing optical characteristics of the sheets/layers. However, the specific temperature and pressure parameters required to produce a hermetic diffusion bond can vary widely depending upon the nature and composition of the two mating surfaces being joined. Therefore, it is possible that some combinations of windowpane material (e.g., glass) and strength-reinforcing material (e.g., plastics or metals) will have a diffusion bonding temperature that exceeds the respective T_{G} and/or the T_{S} of one of the materials, or that exceeds some other temperature limit. In such cases, it might appear that diffusion bonding is unsuitable for use in hermetically joining the components together if the temperature limits are to be followed. In fact, however, it has been discovered that the use of “interlayers,” i.e., intermediate layers of specially selected material placed between the windowpane material and the strength-reinforcing layer, can cause hermetic diffusion bonding to take place at a substantially lower temperature than if the same windowpane material was bonded directly to the same strength-reinforcing layer material.

A properly matched interlayer improves the strength and hermeticity (i.e., gas tightness or vacuum tightness) of a diffusion bond. Further, it may promote the formation of compatible joints, produce a monolithic bond at lower bonding temperatures, reduce internal stresses within the bond zone, and prevent the formation of extremely stable oxides which interfere with diffusion. The interlayer is believed to diffuse into the parent material, thereby raising the melting point of the joint as a whole. Depending upon the materials to be joined by diffusion bonding, the interlayer material could be composed of a metal, a metal alloy, a glass material, a solder glass material including solder glass in tape or sheet form, or other materials. Reliable glass-to-glass and glass-to-metal bonds are achieved with metal interlayers such as Al, Cu, Kovar, Niobium and Ti in the form of foil, usually not over 0.2 mm thick. The interlayers are typically formed into thin preforms shaped like the area of the mating surfaces to be joined.

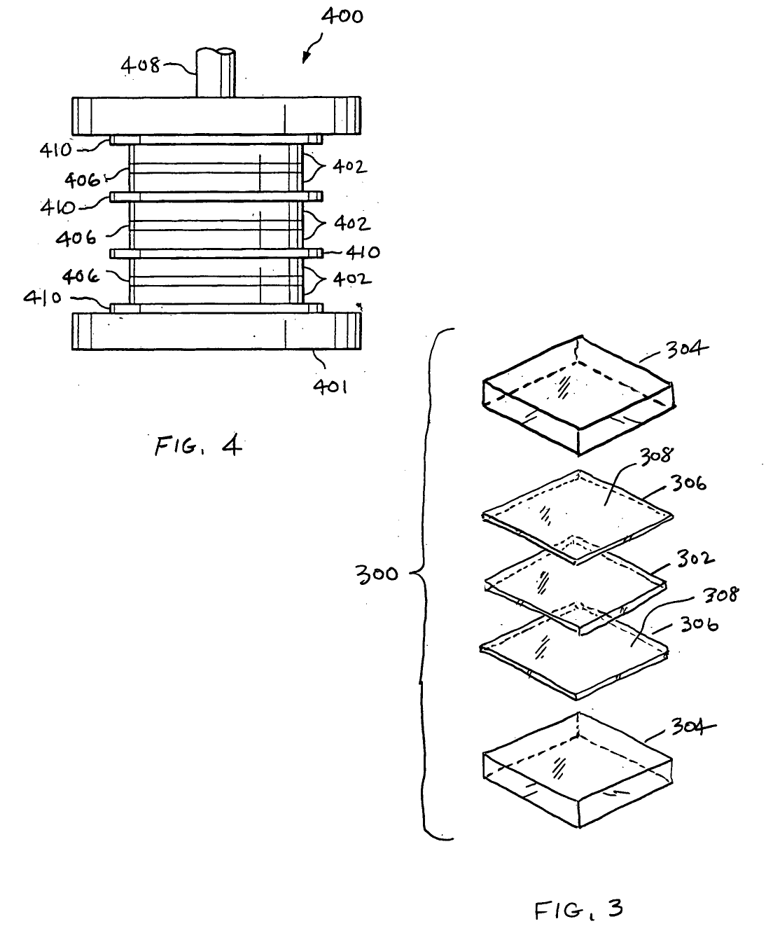

Referring now to FIG. 3, there is illustrated a laminated strength-reinforced window assembly in accordance with another embodiment including interlayers to promote joining by diffusion bonding. The assembly 300 of this embodiment includes a single strength-reinforcing layer 302 positioned between a pair of windowpanes 304, similar to the configuration of FIG. 1a. In this case, however, interlayers 306 are provided between the strength-reinforcing layer 302 and windowpanes 304. The interlayers 306 in this embodiment takes the form of a solder glass preforms which have a configuration selected to match the mating area 308 of the strength-reinforcing layer 302. To form the laminated strength-reinforced window assembly, the strength-reinforcing layer 302, windowpanes 304 and interlayers 306 are placed in a fixture (i.e., tooling) or mechanical apparatus which can provide the required predetermined bonding pressure between the mating areas of the respective components. In some cases, the fixture may serve only to align the components during bonding, while the elevated bonding pressure is applied from a mechanical apparatus such as a ram. In other cases, however, the fixture may be designed to constrain the expansion of the stacked components during heating (i.e., along the stacking axis), whereby the thermal expansion of the assembly components toward the fixture, and of the fixture itself toward the components, will “self-generate” some or all of the necessary bonding pressures between the components as the temperature increases.

The assembled (but not yet bonded) components of the window assembly 300 are then heated until the diffusion bonding pressure/temperature conditions are reached, and these conditions are maintained until a first diffusion bond is formed between the windowpanes 304 and the interlayers 306, and a second diffusion bond is formed between the interlayers 306 and the strength-reinforcing layer 302. It will be understood that the first bond between the windowpanes and the interlayers may actually occur before, after or simultaneously with, the second bond between the interlayers and the strength-reinforcing layer. As previously explained, it will also be understood that the order of applying heat and pressure to form the diffusion bond is not believed to be significant, i.e., in other words whether the pre-determined pressure is applied, and then the heat is applied or whether the heat is applied and then the predetermined pressure is applied, or whether both heat and pressure are increased simultaneously is not believed to be significant, rather the diffusion bonding will occur when the preselected pressure and temperature are present in the bond region for a sufficient amount of time. After the diffusion bonds are formed, the completed assembly 300 will resemble the assembly of FIG. 1; the interlayers may no longer be visible after bonding.

In embodiments using interlayers (e.g., FIG. 3), materials other than glass may be used for the interlayer material. The interlayers may comprise: a glass material; a solder-glass material such as solder-glass in tape form, solder-glass in sheet form, solder-glass in paste form (the paste would be applied by dispensing or by screen-printing onto either the window component or the strength-reinforcing layer component), solder-glass in powder form (the glass powder would be mixed with water, alcohol or another solvent and sprayed or otherwise applied onto either the junction area of the strength-reinforcing layer or the overlapping area of the windowpane); a metal material; a metal alloy material; a material other than glass, glass-solder, metal or metal alloy, including, but not limited to ceramics, composite materials, woven or mesh materials, woven or mesh materials encapsulated in a composite material, a material composed of a combination of glass and metals and/or metal alloys.

It is important to distinguish the use of diffusion bonding interlayers from the use of conventional solder preforms and other processes. For purposes of this application, an interlayer is a material used between mating surfaces to promote the diffusion bonding of the surfaces by allowing the respective mating surfaces to diffusion bond to the interlayer rather than directly to one another. For example, with the proper interlayer material, the diffusion bonding temperature for the joint between the windowpane material and interlayer material, and for the joint between the interlayer material and the strength-reinforcing layer material, may be substantially below the diffusion bonding temperature of a joint formed directly between the windowpane material and the strength-reinforcing layer material. Thus, use of the interlayer allows diffusion bonding of the windowpane to the strength-reinforcing layer at a temperature which is substantially below the diffusion bonding temperature that would be necessary for bonding that windowpane material and that strength-reinforcing layer material directly. The joint, which will preferably be hermetic, is still formed by the diffusion bonding process, i.e., none of the materials involved (the sheet material, the interlayer material nor the strength-reinforcing layer material) melts during the bonding process. This distinguishes diffusion bonding using interlayers from other processes such as the use of solder glass preforms in which the solder material actually melts to form the bond between the materials being joined. It is possible to use materials conventionally used for solders, for example, as interlayers for diffusion bonding. However, when used as interlayers they are used for their diffusion bonding properties and not as conventional solders (in which they melt).

The use of interlayers in the production of window assemblies or other packaging may provide additional advantages over and above their use as promoting diffusion bonding. These advantages include interlayers which serve as activators for the mating surfaces. Sometimes the interlayer materials will have a higher ductility in comparison to the base materials. The interlayers may also compensate for stresses which arise when the seal involves materials having different coefficients of thermal expansion or other thermal expansion properties. The interlayers may also accelerate the mass transfer or chemical reaction between the layers. Finally, the interlayers may serve as buffers to prevent the formation of undesirable chemical or metallic phases in the joint between components.

Referring now to FIG. 4, there is illustrated one apparatus for fixturing multiple sets of laminated strength-reinforced window components for simultaneous diffusion bonding, thereby producing multiple laminated strength-reinforced window assemblies simultaneously. The fixture apparatus 400 includes a base 401 upon which are stacked three sets of windowpanes 402 and strength-reinforcing layers 406 similar to those described in FIGS. 1a and 2a. A hydraulic or pneumatic ram 408 supplies the pressure (i.e., load) against the top of the stack to press the windowpane and strength-reinforcing layers together (against the base) during bonding. Separating the adjacent windowpanes (i.e., those belonging to different assemblies) are dividers 410 formed of a material that will not bond to the windowpanes 402, base 401 or ram 408 under the expected bonding conditions. The entire fixture apparatus is disposed inside a diffusion bonding chamber (not shown). The diffusion bonding chamber heats the fixture 400 and its stacked components to bonding temperature, and causes the ram 408 to apply bonding load (pressure) to the stacked components. The bonding temperature and pressure are maintained for the required bonding time necessary to produce a complete hermetic seal between all of the windowpanes 402 and their respective strength-reinforcing layers 406. During the bonding process, the diffusion bonding chamber may be evacuated, pressurized, and/or filled with one or more gases as necessary to be sure the gap cavities of the assemblies have the desired contents, and/or to promote the bonding of the components. After bonding, the three laminated strength-reinforced window assemblies are complete.

As previously described, the components of pairs of the laminated strength-reinforced window assemblies do not need to be flat. They may be concave, convex or complex in shape, as long as each windowpane mates intimately with the intermediate strength-reinforcement layer, e.g., during the bonding process, the surface of glass (or other window material) is in intimate contact with the surface of the strength-reinforcement layer to which it is bonded.

Also as previously described, the windowpane material for the laminated strength-reinforced window assemblies need not be glass. It could be a different transparent or non-transparent material, including, but not limited to quartz, sapphire, silicon and even metals, metal alloys, and cermics. It could be a non-hermetic material, but the resulting assembly would then be non-hermetic.

As an alternative to conventional diffusion bonding chambers with internal rams (e.g., as illustrated in FIG. 4), another apparatus that is suitable for diffusion bonding the windowpanes to the strength-reinforcing layers to form laminated strength-reinforced window assemblies is known as a Hot Isostatic Press (“HIP”). A HIP unit provides the simultaneous application of heat and high pressure. In the HIP unit, the work pieces (e.g., the window assembly components) are typically sealed inside a vacuum-tight bag, which is then evacuated. The bag with work pieces inside is then sealed within a pressure containment vessel or apparatus, which in turn is a part of, or is contained within, a high temperature furnace. A gas, typically argon, is introduced into the vessel around the bagged parts and the furnace turned on. As the furnace heats the pressure vessel, the temperature and pressure of the gas inside simultaneously increase. The gas pressure supplies great force pressing the bagged parts together, and the gas temperature supplies the heat necessary to allow bonding to occur. A HIP unit allows the temperature, pressure and process time to all be controlled to achieve the optimum material properties.

As yet another alternative to conventional diffusion bonding chambers, the fixture itself, normally used only to hold the components in position for bonding, may be designed to constrain the expansion of the stacked components during heating (i.e., along the stacking axis), whereby the thermal expansion of the assembly components toward the fixture, and of the fixture itself toward the components, will “self-generate” some or all of the necessary bonding pressures between the components as the temperature increases.

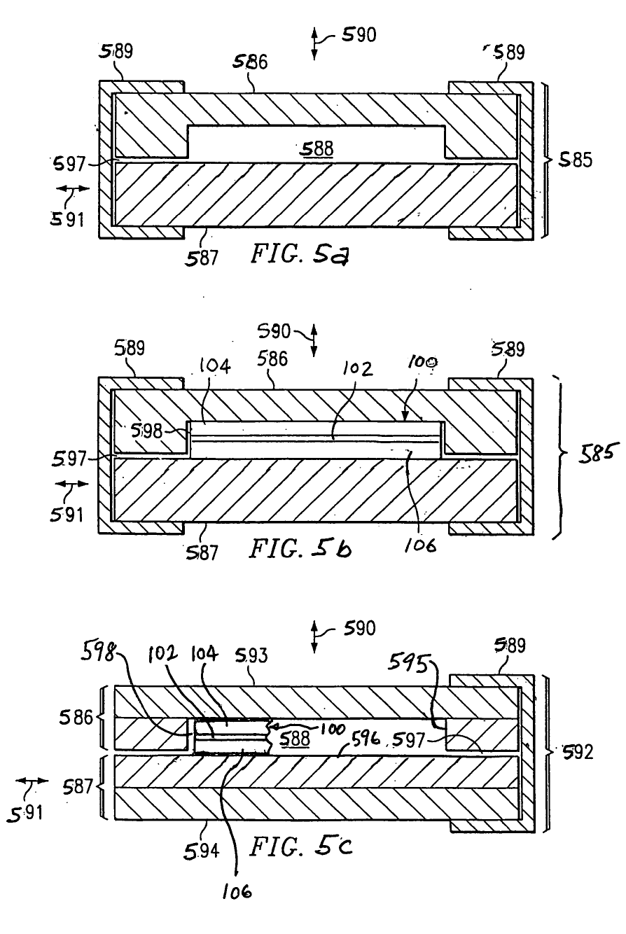

Referring now to FIGS. 5a and 5b, an example of a “self-compressing” fixture assembly is shown. As best seen in FIG. 5a, the fixture 585 includes an upper fixture member 586 and a lower fixture member 587 which together define a cavity 588 for receiving the window assembly components to be bonded. Clamps 589 are provided which constrain the outward movement of the fixture members 586 and 587 in the axial direction (denoted by arrow 590). Generally, the CTE of the material forming the clamps 589 will be lower than the CTE of the material forming the fixture members 586 and 587. FIG. 5b shows the components for a laminated strength-reinforced window assembly 100 (see FIGS. 1a and 1b), including windowpane sheets 104 and 106 and strength-reinforcing sheet 102, loaded into the cavity 588 of the fixture 585 in preparation for bonding. Note that while the fixture members 586 and 587 are in contact with the upper and lower surfaces of the window components, a small gap 597 is left between the fixture members themselves to allow the members to expand axially toward one another when heated (since they are constrained by the clamps). Also note that a small gap 598 is generally left between the lateral sides of the window assembly components and the fixture members 586 and 587 to minimize the lateral force exerted on the components by the fixture members during heating.

When the fixture 585 is heated, the inner surfaces (i.e., facing the cavity 588) of the fixture members 586 and 587 will expand (due to thermal expansion) axially toward one another against the window components, and the window components 102, 104 and 106 will expand outward against the fixture. These thermal expansions can press the window components against one another with great force in the axial direction to facilitate diffusion bonding. It will be appreciated that thermal expansion of the fixture members 586 and 587 will also occur in the lateral direction (denoted by arrow 591). While this lateral expansion is not generally desired, in most cases is will not present an obstacle to the use of self-compressing fixtures.

Referring now to FIG. 5c, there is illustrated an alternative self-compressing fixture adapted to enhance thermal expansion (and hence compression) in the axial direction 590 without causing excessive thermal expansion in the lateral direction 591. As with the previous example, alternative fixture 592 includes an upper fixture member 586 and a lower fixture member 587 defining a cavity 588 for receiving the components of the laminated strength-reinforced window assembly to be bonded, and clamps 589 (only one of which is shown for purposes of illustration) which constrain the outward movement of the fixture members in the axial direction 590. Also as in the previous embodiment, a first small gap 597 is present between the fixture members 586 and 587 themselves, and a second small gap 598 is present between the lateral sides of the window assembly components 102, 104 and 106 (for purposes of illustration, only a portion of the window assembly 100 is shown in FIG. 5c) and the fixture members. Unlike the previous embodiment, however, each fixture member 586 and 587 of the alternative fixture 592 comprises two sub-members. Member 586 comprises outer submember 593 and inner submember 595, while member 587 comprises outer sub-member 594 and inner submember 596. The first (i.e., outer) sub-members 593 and 594, respectively, are adapted primarily to generate the axial force against the window assembly components, and the second (i.e., inner) sub-members 595 and 596, respectively, are adapted to hold and align the window assembly components in the cavity 588. By selecting a material for the first sub-members 593 and 594 having a high CTE, their axial expansion (and hence compression force generated) during heating will be correspondingly high. However, lateral expansion and relative lateral movement between the second sub-members 595 and 596 and the window components can be minimized by selecting a different material for the second sub-members, namely, a material having a lower CTE (i.e., lower than the CTE for the first sub-members). Preferably, the CTE of the second sub-members 595 and 596 will be close to the CTE for the adjacent window components.

Preferably, when fabricating laminated strength-reinforced window assemblies, the coefficient of (linear) thermal expansion (CTE) of the strength-reinforcing layer material(s) is matched as well as possible to the CTE of the associated glass windowpanes. The CTE of most glasses is fairly constant from approximately 273° K. (0° Centigrade) up to the softening temperature of the glass. However, some plastics, metals and alloys have very different CTEs at different temperatures. Therefore, the average CTE of the strength-reinforcing layer material(s) at the elevated glass-to-reinforcing layer bonding temperature should be matched as closely as possible to the average CTE of the glass over the same temperature range. The closer the average CTEs of the two materials, the lower will be the residual stresses in the reinforcing layer and the glass windowpanes after the assembly cools from the elevated bonding temperature back to ambient (room temperature).

The long-term reliability (e.g., the ability to resist delamination or other failure) of the reinforcing layer-to-windowpane bond is affected by the degree of matching of the CTEs of the reinforcing layer material and the windowpane for the anticipated end-use environment. For example, if the window assembly is expected to be exposed to temperatures from −40° C. to 100° C. (−40° F. to 212° F.), then the reinforcing layer material and the windowpane material should have closely matched CTEs over this temperature range. If the CTE of the reinforcing layer material cannot be exactly matched to the CTE of the windowpane material, then it is desirable that the CTE of the reinforcing layer material should be slightly greater than that of the windowpane, especially if the windowpane is made of glass or another brittle material. In such case (i.e., where the CTE of the reinforcing layer material exceeds that of the windowpane), the reinforcing layer would contract more than the windowpane during cool-down from the elevated bonding temperature back to ambient, resulting in the windowpane being in slight compression. This is preferable to the windowpane being in tension, since glass in tension is prone to cracking.

It is thus desirable when designing and fabricating laminated strength-reinforced window assemblies to take into consideration data on the ranges of the coefficient of linear thermal expansion (CTE) of plastics, metals, metal of alloys and other reinforcing layer materials, along with data on the CTE values of glasses and other windowpane materials, so as to ensure the minimum post-bonding stresses, the maximum long-term reliability of the reinforcing layer-to-windowpane seals, and prevention of cracking of the windowpanes.

The temperature parameters for diffusion bonding between the mating surfaces of windowpanes and the reinforcing layers described above are believed to be within the range from about 40% to about 70% of the absolute melting temperature, in degrees Kelvin, of the parent material having the lower melting temperature. When diffusion bonding is used for bonding optically finished glass or other transparent materials, the bonding temperature may be selected to be below the T_{G} and/or the softening temperature of the for the glass other transparent materials, thereby avoiding damage to the optical finish. Depending upon the bonding temperature selected, in some embodiments the application of optical and/or protective coatings to the transparent sheets (i.e., that become the windows) may be performed after the bonding of the sheets to the strength-reinforcing layers, rather than before bonding. In other embodiments, some of the optical and/or protective coatings may be applied to the glass sheets prior to bonding, while other coatings may be applied subsequent to bonding.

While the invention has been shown or described in a variety of its forms, it should be apparent to those skilled in the art that it is not limited to these embodiments, but is susceptible to various changes without departing from the scope of the invention.

What is claimed is:

1. A laminated strength-reinforced window assembly comprising:
a sheet of strength-reinforced transparent material having a tensile strength value, an impact resistance value, an environmental resistance value, an upper sealing surface and a lower sealing surface; the upper sealing surface being disposed on the upper side of the strength-reinforced sheet; the lower sealing surface being disposed on the lower side of the strength-reinforced sheet;
a first and a second transparent windowpane sheets, each windowpane sheet having a respective tensile strength value, a respective impact resistance value and a respective environmental resistance value, the first windowpane sheet being disposed over at least a part of the upper sealing surface and the second windowpane sheet being disposed under at least a part of the lower sealing surface;
at least one of the tensile strength value, the impact resistance value and the environmental resistance value of the strength-reinforced material being significantly greater than the corresponding value of one of the first and second windowpanes; and
the first and second transparent windowpane sheets being each hermetically bonded to the sheet of strength-reinforced material without non-hermetic adhesives to form a continuous hermetic joint therebetween.

2. A laminated strength-reinforced window assembly in accordance with claim 1, wherein the hermetic bonds between the strength-reinforced sheet and the first and second transparent windowpane sheets are diffusion bonds.

3. A laminated strength-reinforced window assembly in accordance with claim 2, further comprising:
an interlayer formed of a material different from the material of the strength-reinforced sheet and the material of either windowpane sheet, the interlayer being disposed between the sealing surface of the strength-reinforced sheet and at least one of the windowpane sheets prior to diffusion bonding and being incorporated into the hermetic joint after bonding.

4. A laminated strength-reinforced window assembly in accordance with claim 2, wherein the material of the first windowpane sheet is different from the material of the second windowpane sheet.

5. A window unit for installation in a building, comprising:
a unit frame adapted for installation into the rough-in framing structure of a building during construction; and
at least one laminated strength-reinforced window assembly in accordance with claim 1, the window assembly being mounted into the unit frame.

6. A window unit for installation in a building, comprising:
a unit frame adapted for installation into the finished structure of a building after construction; and
at least one laminated strength-reinforced window assembly in accordance with claim 1, the window assembly being mounted into the unit frame.

7. A window unit for installation in a vehicle, comprising:
a unit frame adapted for installation into the structure of the vehicle during initial assembly; and
at least one laminated strength-reinforced window assembly in accordance with claim 1, the window assembly being mounted into the unit frame.

8. A window unit for installation in a vehicle, comprising:
a unit frame adapted for field installation into the finished structure of the vehicle after initial assembly; and
at least one laminated strength-reinforced window assembly in accordance with claim 1, the window assembly being mounted into the unit frame.

9. A laminated strength-reinforced window assembly comprising:
n sheet(s) of strength-reinforcing material, where n>=1, each sheet of strength-reinforcing material having a tensile strength value, an impact resistance value, an environmental resistance value, an upper sealing surface and a lower sealing surface;
(n+1) transparent windowpane sheets, each windowpane sheet having a respective tensile strength value, a respective impact resistance value and a respective environmental resistance value, the windowpane sheets being interleaved with the sheet(s) of strength-reinforcing material such that one sheet of strength-reinforcing material lies against each consecutive windowpane sheet, the sheet of strength-reinforcing material being disposed to have at least a part of the upper sealing surface overlapping one of the adjacent windowpane sheets, and at least a part of the lower sealing surface overlapping the other adjacent windowpane sheet;
at least one of the tensile strength value, the impact resistance value and the environmental resistance value of each sheet of strength-reinforced material being significantly greater than the corresponding value of one of the directly adjacent windowpane sheets; and
all of the windowpane sheets being hermetically bonded to the adjacent sheet(s) of strength-reinforcing material without non-hermetic adhesives.

10. A laminated strength-reinforced window assembly in accordance with claim 9, wherein the hermetic bonds between the strength-reinforced sheet(s) and the windowpane sheets are diffusion bonds.

11. A laminated strength-reinforced window assembly in accordance with claim 9, wherein at least two of the transparent windowpane sheets are formed of different materials.

12. A laminated strength-reinforced window assembly in accordance with claim 9, wherein:
n>=2; and
at least two of the sheets of strength-reinforcing material are formed of different materials.

13. A method for producing laminated strength-reinforced window assembly, comprising the following steps:
providing a sheet of strength-reinforced transparent material having an upper sealing surface and a lower sealing surface, the upper sealing surface being disposed on the upper side of the strength-reinforced sheet, and the lower sealing surface being disposed on the lower side of the strength-reinforced sheet;
providing a first transparent windowpane sheet and a second transparent windowpane sheet;
positioning the first windowpane sheet against at least a part of the upper sealing surface, the overlap between them defining an upper junction, and positioning the second windowpane sheet against at least a part of the lower sealing surface, the overlap between them defining a lower junction;
pressing the windowpane sheets against the sheet of strength-reinforced material with sufficient force to produce a predetermined contact pressure throughout the upper and lower junctions;
heating the junctions to produce a predetermined temperature throughout the junctions; and
maintaining the predetermined contact pressure and the predetermined temperature until a diffusion bond is formed between the windowpane sheets and the sheet of strength-reinforced material throughout the junction.

14. A method in accordance with claim 13, wherein the step of pressing the windowpane sheets against the sheet of strength-reinforced material is performed before the step of heating the junctions.

15. A method in accordance with claim 13, wherein the step of heating the junctions is performed before the step of pressing the windowpane sheets against the sheet of strength-reinforced material.

16. A method in accordance with claim 13 wherein the steps of pressing the windowpane sheets against the sheet of strength-reinforced material and of heating the junctions are performed simultaneously.

17. A method in accordance with claim 13, wherein during the step of heating the junctions, the temperature of the sheets remains below the glass transition temperature (T_{G}) of the respective materials from which the sheets are formed.

18. A method in accordance with claim 13, wherein during the step of heating the junctions, the temperature of the sheets remains below the softening temperature (T_{S}) of the respective materials from which the sheets are formed.

19. A laminated strength-reinforced window assembly comprising:
a first sheet of transparent material having a tensile strength value, an impact resistance value, an environmental resistance value and a sealing surface;
a second sheet of transparent material having a tensile strength value, an impact resistance value, an environmental resistance value and a sealing surface;
at least one of the tensile strength value, the impact resistance value and the environmental resistance value of the material of the first sheet being significantly greater than the corresponding value of the material of the second sheet;
the sealing surface of the first sheet being disposed against the sealing surface of the second sheet; and
the first and second sheets being hermetically bonded to one another along the sealing surfaces without non-hermetic adhesives to form a continuous hermetic joint therebetween.

20. A laminated strength-reinforced window assembly in accordance with claim 19, wherein the hermetic bond between the sheets is a diffusion bond.
